(19) United States
(12) Patent Application Publication
(10) Pub. No.: US 2010/0039816 A1
(43) Pub. Date: Feb. 18, 2010

(54) LED warning lamp

(76) Inventor: Peter Yeh, Hsinhua Chen (TW)

Correspondence Address: JACKSON WALKER, L.L.P., 112 E. PECAN, SUITE 2400, SAN ANTONIO, TX, 78205, US

(21) Appl. No.: 12/228,464

(22) Filed: Aug. 13, 2008

(51) Int. Cl. F21S 13/14

(52) U.S. Cl. 362/249.14

(57) ABSTRACT

An LED warning lamp comprises a base, multiple lighting assemblies, a junction and a cover. The base has a cone protruding from the base and having an opening formed in an apex of the cone. Each lighting assembly has a circuit board and multiple LEDs mounted on the circuit board. Each circuit board is mounted on the cone and has a top connector having multiple contacts being connected to the LEDs. The junction is mounted on the opening and has multiple edges corresponding to the circuit boards, multiple recessed connectors formed respectively in the edges and respectively engaging the top connectors, a circuit and multiple wires. The circuit has multiple contacts respectively connecting to corresponding contacts of the top connectors. The wires are connected to the circuit of the junction and are mounted in the cone through the opening. Therefore, wiring is simplified for lower cost and production time.

### BACKGROUND OF THE INVENTION

1. Field of the Invention

The present invention relates to a lamp, especially to a warning lamp that uses LEDs as light sources with simple wiring to reduce production time and costs.

2. Description of the Related Art

LEDs (Light Emitting Diodes) are commonly used as lighting elements in many warning lamps because of high lighting efficiency, long life span, durability and low power consumption.

With reference to FIG. 6, a conventional LED warning lamp has a base (60), multiple lighting assemblies (70), a cover (80) and a washer (90) mounted on the base (60) by multiple fasteners (900). The base (60) has a cuboidal tube (61) protruding from a center of the base (60). The lighting assemblies (70) are respectively mounted on four sides of the tube (61) and each has a circuit board (71) and multiple LEDs (72) mounted on the circuit board (71). Each circuit board (71) has two wires (700) being connected to the circuit board (71) and extending into the tube (61) to connect to a power source for providing power to the LEDs (72). The cover (80) is mounted on the base (60), abuts against the washer (90) and covers the lighting assemblies (70).

However the wires (700) must be individually mounted on the circuit board (71) and fed through the cubical tube (61) that is narrow and feeding the wires (700) may cause damage or disconnection of the wires (700) from the lighting assemblies (70). Therefore wiring is awkward and inconvenient and may be time-consuming.

To overcome the shortcomings, the present invention provides an LED warning lamp to mitigate or obviate the aforementioned problems.

### SUMMARY OF THE INVENTION

The main objective of the invention is to provide a warning lamp that uses LEDs as light sources with simple wiring to reduce production time and costs.

An LED warning lamp in accordance with the present invention comprises a base, multiple lighting assemblies, a junction and a cover. The base has a cone protruding upward from the base and having an opening formed in an apex of the cone. Each lighting assembly has a circuit board and multiple LEDs mounted on the circuit board. Each circuit board is mounted on the cone and has a top connector having multiple contacts being connected to the LEDs. The junction is mounted on the opening and has multiple edges, multiple recessed connectors, a circuit and multiple wires. The edges correspond to a number of lighting assemblies. The recessed connectors are respectively formed in the edges and respectively engage the top connectors. The circuit has multiple contacts respectively extending to the recessed connectors and connecting to corresponding contacts of the top connectors. The wires are connected to the circuit of the junction and are mounted in the cone through the opening. The cover is mounted on the base and covers the cone and the lighting assemblies.

The junction and the connection with the circuit boards of the lighting assemblies simplifies wiring and thus reduces production time and cost.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an LED warning lamp in accordance with the present invention;

FIG. 2 is an assembled perspective view of the LED warning lamp in FIG. 1, a cover shown removed;

FIG. 3 is a top perspective view of the LED warning lamp in FIG. 1;

FIG. 4 is a bottom perspective view of the LED warning lamp in FIG. 1;

FIG. 5 is a side view in partial section of the LED warning lamp in FIG. 3; and

FIG. 6 is a partially exploded perspective view of an LED warning lamp in accordance with the prior art.

### DETAILED DESCRIPTION OF THE PREFERRED EMBODIMENTS

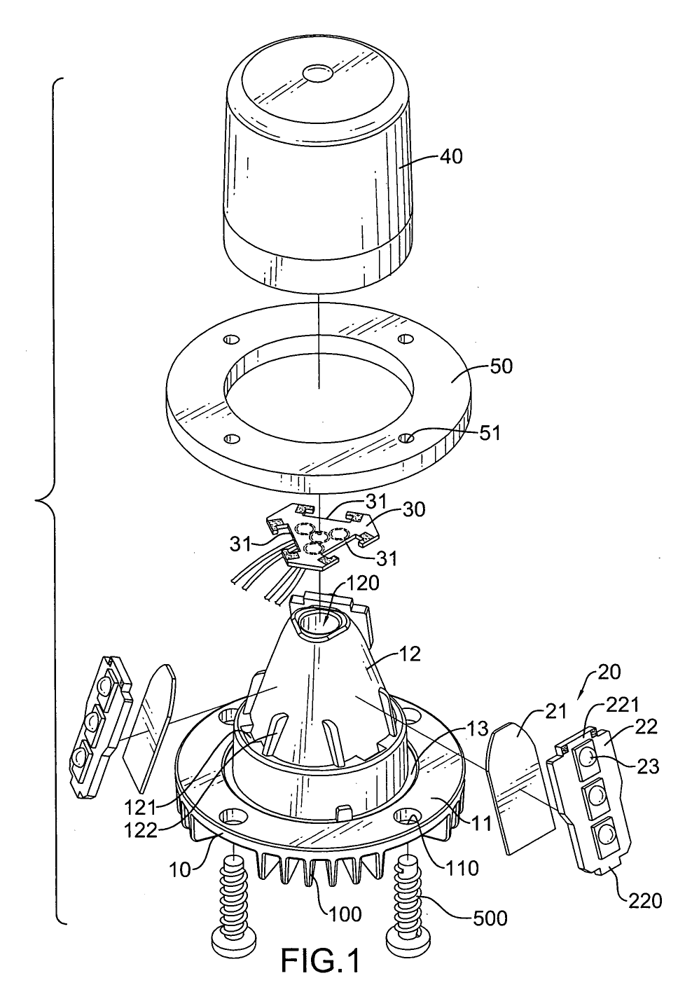

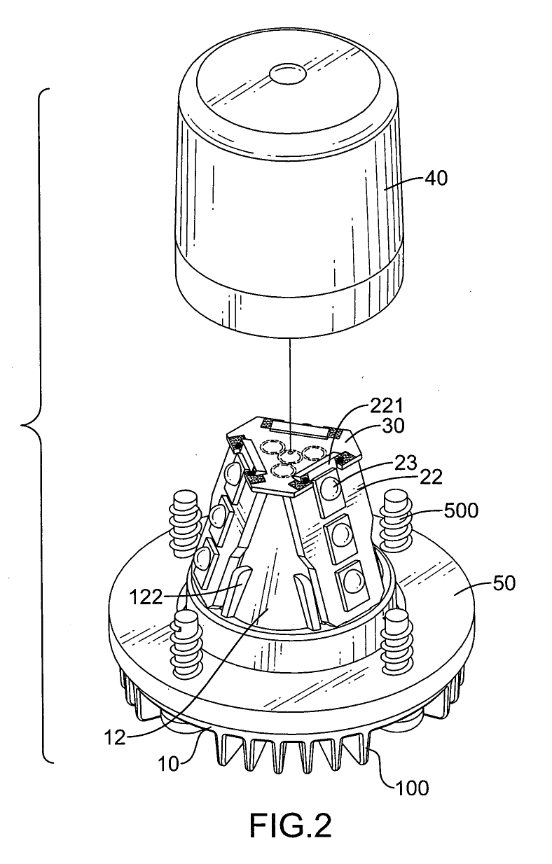

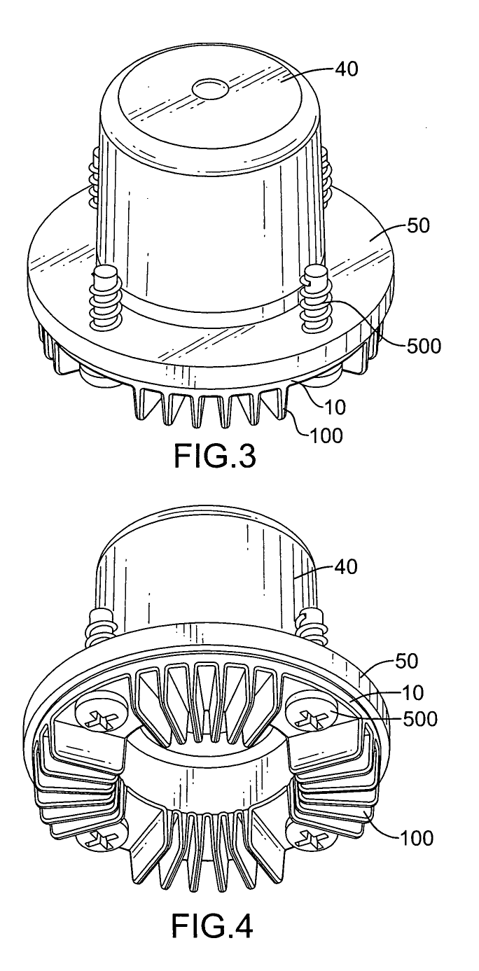

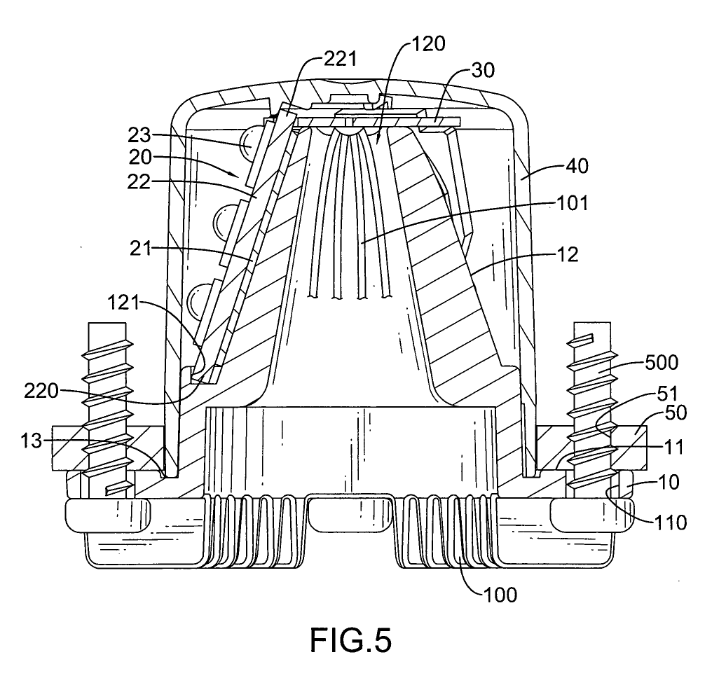

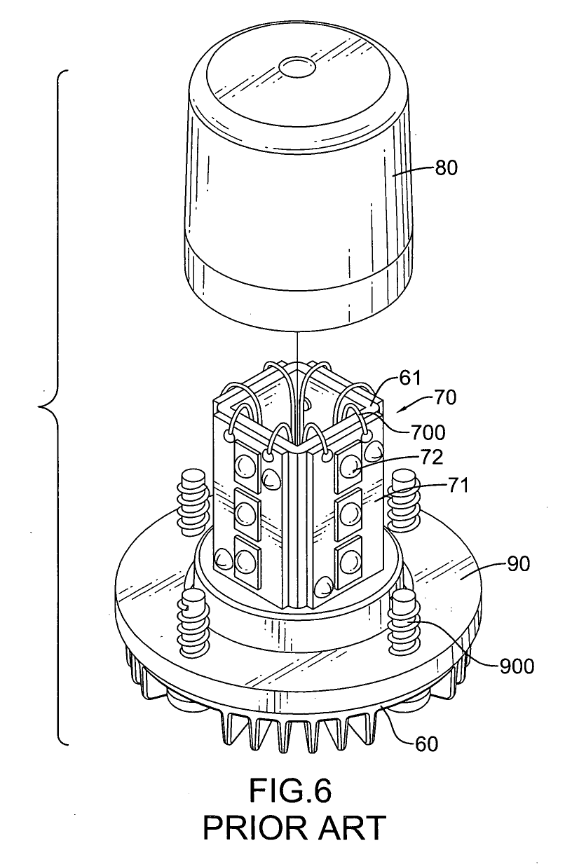

With reference to FIGS. 1 to 5, an LED warning lamp in accordance with the present invention comprises a base (10), multiple lighting assemblies (20), a junction (30), a cover (40) and may have a washer (50).

The base (10) has an outer surface (11), an inner surface and a cone (12) and may have multiple fins (100) and an annular groove (13). The outer surface (11) has a center and may have multiple threaded holes (110) being formed through the outer surface (11).

The cone (12) is formed on and protrudes from the center of the outer surface (11) and has an apex, a bottom, a conical surface, an opening (120), multiple mounting grooves (121) and may have multiple positioning tabs (122). The opening (120) is formed in the apex of the cone (12). The mounting grooves (121) are separately formed around the bottom of the cone (12). The positioning tabs (122) are formed on the conical surface in pairs and each pair of positioning tabs (122) is disposed adjacent to both sides of a corresponding mounting groove (121). The bottom of the cone (12) may be an annulus formed between the outer surface (11) of the base (10) and the conical surface of the cone (12).

The fins (100) are formed on and protrude from the inner surface of the base (10).

The annular groove (13) is formed around the bottom of the cone (12).

The lighting assemblies (20) are mounted on the conical surface of the cone (12) and each lighting assembly (20) has a circuit board (22), an optional pad (21) and multiple LEDs (23).

The circuit board (22) is mounted on the conical surface, may be between a pair of positioning tabs (122) and has a bottom connector (220) and a top connector (221). The bottom connector (220) protrudes from the circuit board (22) and is mounted securely in a corresponding mounting groove (121) of the cone (12). The top connector (221) protrudes from the circuit board (22) and has multiple contacts formed on an edge of the top connector (221).

The pad (21) is disposed between the circuit board (22) and the conical surface of the cone (12), adjacent to a corresponding mounting groove (121), may be between the corresponding pair of positioning tabs (122).

The LEDs (23) are mounted on the circuit board (22) and are electrically connected to the contacts of the top connector (221).

Preferably three lighting assemblies (20) are implemented.

The junction (30) is mounted on the opening (120) of the cone (12) and has multiple edges, an inner surface, multiple recessed connectors (31), a circuit and multiple wires (101). A number of edges corresponds to a number of lighting assemblies (20), preferably three edges are implemented. The recessed connectors (31) are formed respectively in the edges of the junction (30) and respectively engage the top connectors (221) of the circuit boards (22). The circuit is mounted on the inner surface of the junction (30) and has multiple contacts. The contacts of the circuit respectively extend to the recessed connectors (31) and are electrically connected to corresponding contacts of the top connectors (221) of the circuit board (22) by soldering. The wires (101) are attached to the bottom of the junction (30), are connected to the circuit of the junction (30) and are mounted in the cone (12) through the opening (120) of the cone (12). The wires (101) are adapted to connect to an external power source maybe through a control circuit controlling flash sequences of the LEDs (23). Therefore the LEDs (23) obtain power from the wires (101) via the connectors (221, 31) of the circuit board (22) and the junction (30).

The cover (40) is mounted on the base (10) and covers the cone (12) and the lighting assemblies (20) and may be mounted in the annular groove (13), may correspond to and abut the bottom of the cone (12).

The washer (50) is mounted on the outer surface (11) of the base (10) with multiple fasteners (500), surrounds and abuts the cover (40) and has multiple through holes (51). The through holes (51) respectively align with the threaded holes (110) of the base (10). The fasteners (500) are mounted through the threaded holes (110) and the through holes (51) to hold the washer (50) securely on the base (10).

The junction (30) and the connection with circuit boards (22) of the lighting assemblies (20) provide a simple structure for mounting lighting assemblies (20), wiring work can be substantially performed distinct from assembly of the lighting assemblies in the cone so has more space and is less awkward for improved production time and ease while reducing numbers of wires required for reduced cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED warning lamp comprising:
a base having
an outer surface having a center;
an inner surface; and
a cone being formed on and protruding from the center of the outer surface and having
an apex;
a bottom;
a conical surface;
an opening being formed in the apex; and
multiple mounting grooves being separately formed around the bottom of the cone;
multiple lighting assemblies being mounted on the conical surface of the cone and each lighting assembly having
a circuit board being mounted on the conical surface of the cone and having
a bottom connector protruding from the circuit board and being mounted securely in a corresponding mounting groove of the cone; and
a top connector protruding from the circuit board and having multiple contacts being formed on an edge of the top connector; and
multiple LEDs being mounted on the circuit board and being electrically connected to the contacts of the top connector;
a junction being mounted on the opening of the cone and having
multiple edges corresponding to a number of lighting assemblies;
an inner surface;
multiple recessed connectors being formed respectively in the edges of the junction and respectively engaging the top connectors of the circuit boards;
a circuit being mounted on the inner surface of the junction and having multiple contacts respectively extending to the recessed connectors and being electrically connected to corresponding contacts of the top connectors of the circuit board by soldering; and
multiple wires being attached to the bottom of the junction, being connected to the circuit of the junction and being mounted in the cone through the opening of the cone; and
a cover being mounted on the base and covering the cone and the lighting assemblies.

2. The LED warning lamp as claimed in claim 1, wherein the base further has multiple fins being formed on and protruding from the inner surface of the base.

3. The LED warning lamp as claimed in claim 1, wherein
the base further has an annular groove being formed around the bottom of the cone; and
the cover is mounted in the annular groove with an bottom edge.

4. The LED warning lamp as claimed in claim 1, wherein the cone of the base further has multiple positioning tabs being formed on the conical surface of the cone in pairs and each pair of positioning tabs being disposed adjacent to both sides of a corresponding mounting groove.

5. The LED warning lamp as claimed in claim 1, wherein each lighting assembly further has a pad being disposed between the conical surface of the cone and the circuit board adjacent to a corresponding mounting groove.

6. The LED warning lamp as claimed in claim 4, wherein each lighting assembly further has a pad being disposed between the conical surface of the cone and the circuit board adjacent to a corresponding mounting groove and between the corresponding positioning tabs.

7. The LED warning lamp as claimed in claim 1, wherein
the outer surface of the base further has multiple threaded holes being formed through the outer surface; and
the LED warning lamp further comprises a washer being mounted on the outer surface of the base with multiple fasteners, surrounding and abutting the cover and having multiple through holes respectively aligning to the threaded holes of the base.

8. The LED warning lamp as claimed in claim 1, wherein the bottom of the cone is an annulus formed between the outer surface of the base and the conical surface of the cone.

9. The LED warning lamp as claimed in claim 1, wherein three lighting assemblies and three edges of the junction are implemented.

10. The LED warning lamp as claimed in claim 1, wherein the wires are adapted to connect to an external power source.

11. The LED warning lamp as claimed in claim 8, wherein the cover corresponds to and abuts the bottom of the cone.

12. The LED warning lamp as claimed in claim 6, wherein
the base further has an annular groove being formed around the bottom of the cone; and
the cover is mounted in the annular groove with an bottom edge.

13. The LED warning lamp as claimed in claim 12, wherein the base further has multiple fins being formed on and protruding from the inner surface of the base.

14. The LED warning lamp as claimed in claim 13, wherein
the outer surface of the base further has multiple threaded holes being formed through the outer surface; and
the LED warning lamp further comprises a washer being mounted on the outer surface of the base with multiple fasteners, surrounding and abutting the cover and having multiple through holes respectively aligning to the threaded holes of the base.

15. The LED warning lamp as claimed in claim 14, wherein the bottom of the cone is an annulus formed between the outer surface of the base and the conical surface of the cone.

16. The LED warning lamp as claimed in claim 15, wherein three lighting assemblies and three edges of the junction are implemented.

17. The LED warning lamp as claimed in claim 16, wherein the cover corresponds to and abuts the bottom of the cone.
